(19) United States
(12) Patent Application Publication
(10) Pub. No.: US 2008/0108395 A1
(43) Pub. Date: May 8, 2008

(54) PORTABLE SUB-BATTERY PACK, PORTABLE COMMUNICATION TERMINAL, AND SYSTEM FOR CRADLING PORTABLE COMMUNICATION TERMINAL

(75) Inventors: Kyung-Jin LEE, Seoul (KR); Joon-Suh KIM, Anyang-si (KR); Chang-Soo LEE, Incheon (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/935,797

(22) Filed: Nov. 6, 2007

(30) Foreign Application Priority Data
Nov. 6, 2006 (KR) 10-2006-0108887

(51) Int. Cl. H04M 1/00

(52) U.S. Cl. 455/572

(57) ABSTRACT

A sub-battery pack capable of providing a charging function, a sub-battery pack function, and a cradling function is disclosed. A sub-battery pack for a portable communication terminal includes a cradle housing to receive the portable communication terminal, a battery pack to cradle the portable communication terminal at an incline when the battery pack is rotated from the cradle housing, and a hinge unit to rotatably couple the battery pack with the cradle housing.

### CROSS-REFERENCE TO RELATED APPLICATION

This application claims priority from and the benefit of Korean Patent Application No. 10-2006-0108887, filed on Nov. 6, 2006, which is hereby incorporated by reference for all purposes as if fully set forth herein.

### BACKGROUND OF THE INVENTION

1. Field of the Invention

The present invention relates to a portable communication terminal, such as a cellular phone, a Personal Communication Service (PCS) terminal, a Personal Digital Assistant (PDA), or a Hand Held Phone (HHP), and in particular, to a sub-battery pack that may be convenient to carry and capable of serving as a cradle.

2. Discussion of the Background

Generally, a “portable communication terminal” refers to an electronic apparatus that a user may carry and use to perform wireless communication. The wireless communication may be voice communication, message transmission, file transmission, video communication, or a camera function. Additionally, the portable communication terminal may serve as a personal agent by performing phone number management and personal schedule management.

In terms of portability, the designs of such portable communication terminals have emphasized not only compactness, slimness, excellent gripping properties, and lightness, but also multimedia availability and thus may have a wide variety of functions, e.g., entertainment functions including game services. In particular, future portable communication terminals are expected to incorporate greater multi-functionality and multi-purpose utilization including video communication, games, Internet, and camera functions as well as voice communication functions.

In a conventional portable communication terminal, a battery pack may be removed from a main body. The battery pack may include battery cells and may be recharged using a separate charging device. The separate charging device includes a slot for charging a portable communication terminal having the battery pack mounted therein or a separate battery pack.

However, once the power of the battery pack is entirely depleted, a user on the move may not be able to use the portable communication terminal any longer. However, it also may be inconvenient for a user to carry a separate charging cradle at all times.

When viewing data displayed on a display unit of a portable communication terminal, in particular, on a desk, a user may conveniently view the data only when the display unit is cradled in an inclined position before the user.

However, it may not be economical for the user to purchase a separate cradle.

Therefore, there is a need for a device that can provide a charging function while being carried, a battery pack function, and a cradling function.

### SUMMARY OF THE INVENTION

The present invention provides a sub-battery pack that may be easy to carry, may provide a charging function, and may be capable of serving as a cradle, thereby optimizing user convenience and making it easy to charge and cradle a portable communication terminal.

The present invention also provides a portable communication terminal including a sub-battery pack and cradle housing that may be combined with a main body to serve as an external case for the main body, which may protect the main body.

The present invention also provides a system for cradling a portable communication terminal.

Additional features of the present invention will be set forth in the description which follows, and in part will be apparent from the description, or may be learned by practice of the invention.

The present invention discloses a sub-battery pack for a portable communication terminal. The sub-battery pack includes a cradle housing, a battery pack, and a hinge unit. The cradle housing receives the portable communication terminal. The battery pack may cradle the portable communication terminal at an incline when the battery pack is rotated from the cradle housing, and the hinge unit rotatably couples the battery pack with the cradle housing.

The present invention also discloses a portable communication terminal including a main body, a cradle housing, a sub-battery pack, and a hinge unit rotatably coupling the sub-battery pack with the cradle housing. The cradle housing is detachably coupled with the main body and the sub-battery pack cradles the main body at an incline when the sub-battery pack is rotated from the cradle housing.

The present invention also discloses a system for cradling a portable communication terminal including a portable communication terminal, a cradle housing, a sub-battery pack, and a hinge unit rotatably coupling the sub-battery pack with the cradle housing. The cradle housing receives the portable communication terminal and the sub-battery pack cradles the portable communication terminal at an incline when the sub-battery pack is rotated from the cradle housing.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 and FIG. 2 are perspective views showing front and rear sides of a portable sub-battery pack and charging cradle combination device according to an exemplary embodiment of the present invention.

FIG. 3 is a side view of FIG. 1.

FIG. 4 is a perspective view showing a portable communication terminal combined with a portable sub-battery pack and charging cradle combination device according to an exemplary embodiment of the present invention.

FIG. 5 is a side view showing a portable communication terminal that is inclined and cradled in a portable sub-battery pack and charging cradle combination device according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

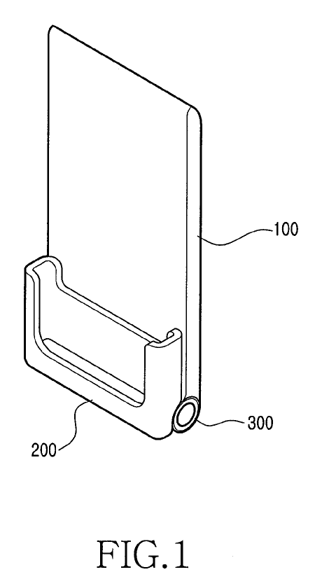

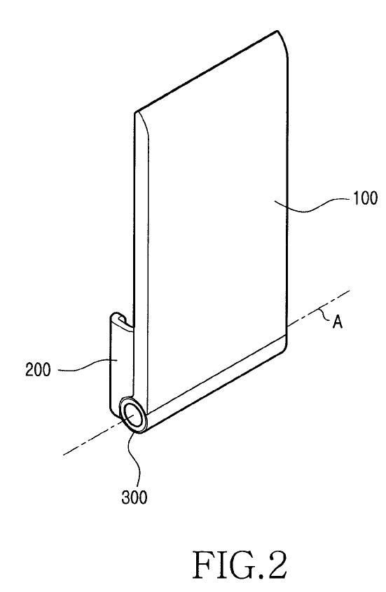

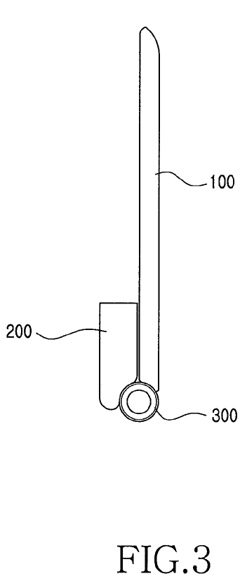

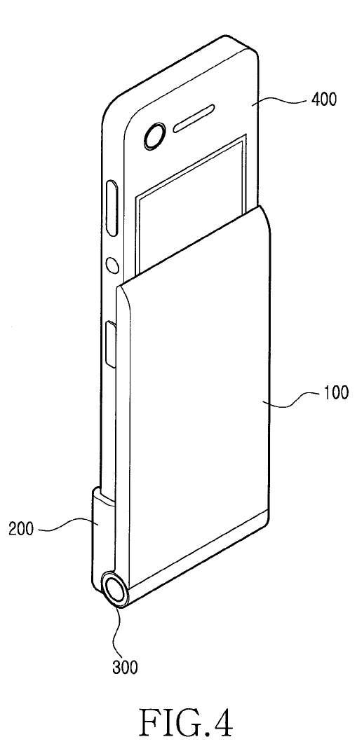

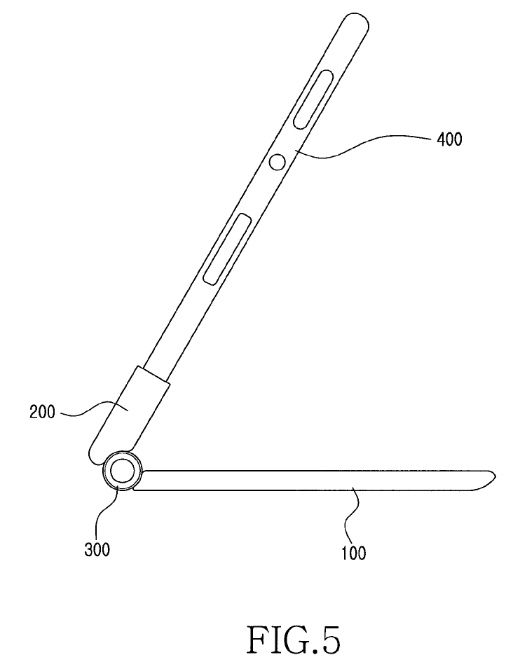

As shown in FIG. 1, FIG. 2, FIG. 3, FIG. 4, and FIG. 5, a portable sub-battery pack and charging cradle combination device according to exemplary embodiments of the present invention includes a battery pack 100, a cradle housing 200, and a hinge unit 300 to rotatably couple the battery pack 100 to the cradle housing 200. A portable communication terminal 400 may be stably combined with the cradle housing 200. The battery pack 100 rotates with respect to a hinge axis A provided by the hinge unit 300 in order to cradle the portable communication terminal 400 cradled in the cradle housing 200 at an incline, as shown in FIG. 5.

The hinge unit 300 rotatably couples the cradle housing 200 with the battery pack 100 and serves as a path along which a flexible circuit (not shown) passes. The flexible circuit connects the battery pack 100 to the portable communication terminal 400. Moreover, a charging connection unit may be disposed on the bottom of the cradle housing 200. The charging connection unit may be in the form of a connector.

The cradle housing 200 may have a slot that allows a lower end portion of the portable communication terminal 400 to be inserted into the cradle housing 200 in consideration of portability. The battery pack 100 also may rotate from the cradle housing 200 in order to cradle the portable communication terminal 400 at an incline, as shown in FIG. 5.

The hinge unit 300 may operate semi-automatically and may provide a stop force to the battery pack 100 at a predetermined angle, thereby allowing the cradled portable communication terminal 400 to be cradled in an inclined position.

The battery pack 100 may be manufactured to have a small size and may include a slot corresponding to an end portion of the portable communication terminal 400 so that it may be conveniently carried and used as a sub-battery pack for a main battery pack included in the portable communication terminal 400. In other words, if the power of a main battery pack of the portable communication terminal 400 is entirely depleted and a user does not have a separate charging device because the user is in transit, the battery pack 100 according to exemplary embodiments of the present invention may be used as a supplemental battery pack by combining the portable communication terminal 400 with the cradle housing 200.

Moreover, the portable communication terminal 400 may be cradled in an inclined position merely by rotating the battery pack 100, and a charging operation may be completed merely by combining the portable communication terminal 400 with the cradle housing 200.

As shown in FIG. 4, when the power of the main battery pack of the portable communication terminal 400 is entirely depleted, the portable communication terminal 400 may be used while combined with the cradle housing 200. In this case, the supplemental battery pack 100 may supply power to the portable communication terminal 400.

As described above, the supplemental battery pack and charging cradle combination device according to exemplary embodiments of the present invention may be easy to carry and may be economical, particularly in terms of a function of charging the main battery pack of the portable communication terminal, a function of serving as a supplemental battery pack, and a function of instantly cradling the portable communication terminal.

It will be apparent to those skilled in the art that various modifications and variations can be made in the present invention without departing from the spirit or scope of the invention provided they come within the scope of the appended claims and their equivalents.

What is claimed is:

1. A sub-battery pack for a portable communication terminal, comprising:
a cradle housing to receive the portable communication terminal;
a battery pack to cradle the portable communication terminal at an incline when the battery pack is rotated from the cradle housing; and
a hinge unit to rotatably couple the battery pack with the cradle housing.

2. The sub-battery pack of claim 1, wherein the battery pack is a supplemental charging device.

3. The sub-battery pack of claim 1, wherein the cradle housing comprises a slot into which a lower end portion of the portable communication terminal may be inserted.

4. A portable communication terminal, comprising:
a main body;
a cradle housing detachably coupled with the main body;
a sub-battery pack to cradle the main body at an incline when the sub-battery pack is rotated from the cradle housing; and
a hinge unit rotatably coupling the sub-battery pack with the cradle housing.

5. The portable communication terminal of claim 4, further comprising a main battery pack to provide power to the main body, wherein the sub-battery pack is a supplemental battery to provide power to the main body.

6. The portable communication terminal of claim 5, wherein the cradle housing comprises a slot to receive an end portion of the main body.

7. The portable communication terminal of claim 6, further comprising a flexible circuit electrically connecting the sub-battery pack with the main body.

8. A system for cradling a portable communication terminal, comprising:
a portable communication terminal;
a cradle housing to receive the portable communication terminal;
a sub-battery pack to cradle the portable communication terminal at an incline when the sub-battery pack is rotated from the cradle housing; and
a hinge unit rotatably coupling the sub-battery pack with the cradle housing.

9. The system of claim 8, wherein the portable communication terminal comprises a main battery pack, and the sub-battery pack is a supplemental battery to provide power to the portable communication terminal.

10. The system of claim 9, wherein the cradle housing comprises a slot to receive an end portion of the portable communication terminal.

11. The system of claim 10, further comprising a flexible circuit electrically connecting the sub-battery pack with the portable communication terminal.
